(19) United States
(12) Patent Application Publication
(10) Pub. No.: US 2021/0389948 A1
(43) Pub. Date: Dec. 16, 2021

(54) MIXED-ELEMENT-SIZE INSTRUCTION

(71) Applicant: Arm Limited, Cambridge (GB)

(72) Inventors: Jesse Garrett BEU, Austin, TX (US); Dibakar GOPE, Austin, TX (US); David Hennah MANSELL, Norwich (GB)

(21) Appl. No.: 16/897,483

(22) Filed: Jun. 10, 2020

(51) Int. Cl. G06F 9/30

(52) U.S. Cl. CPC G06F 9/30149; G06F 9/3016; G06F 9/30029; G06F 9/3001; G06F 9/30112

(57) ABSTRACT

A mixed-element-size instruction is described, which specifies a first operand and a second operand stored in registers. In response to the mixed-element-size instruction, an instruction decoder controls processing circuitry to perform an arithmetic/logical operation on two or more first data elements of the first operand and two or more second data elements of the second operand, where the first data elements have a larger data element size than the second data elements. This is particularly useful for machine learning applications to improve processing throughput and memory bandwidth utilisation.

### BACKGROUND

### Technical Field

The present technique relates to the field of data processing.

### Technical Background

A processor may have processing circuitry to perform data processing in response to program instructions decoded by an instruction decoder, and registers for storing operands for processing by the processing circuitry. Some processors may support single-instruction-multiple-data (SIMD) instructions which specify SIMD operands, where a SIMD operand comprises two or more independent data elements within a single register. This means that the processing circuitry can process a greater number of data values in a single instruction than would be possible with scalar instructions which treat each operand as a single data value.

### SUMMARY

At least some examples provide an apparatus comprising:
an instruction decoder to decode program instructions;
processing circuitry to perform data processing in response to the program instructions decoded by the instruction decoder; and
a plurality of registers to store operands for processing by the processing circuitry; in which:
in response to a mixed-element-size instruction specifying a first operand and a second operand stored in the registers, the instruction decoder is configured to control the processing circuitry to perform an arithmetic/logical operation on a plurality of first data elements of the first operand and a plurality of second data elements of the second operand,
where the first data elements have a larger data element size than the second data elements.

At least some examples provide a data processing method comprising:
decoding program instructions using an instruction decoder;
performing data processing using processing circuitry in response to the program instructions decoded by the instruction decoder; and
storing, in registers, operands for processing by the processing circuitry;
the method comprising:
in response to a mixed-element-size instruction specifying a first operand and a second operand stored in the registers, controlling the processing circuitry to perform an arithmetic/logical operation on a plurality of first data elements of the first operand and a plurality of second data elements of the second operand,
where the first data elements have a larger data element size than the second data elements.

At least some examples provide a non-transitory storage medium storing a computer program for controlling a host data processing apparatus to provide an instruction execution environment for execution of instructions of target code; the computer program comprising:
instruction decoding program logic to decode program instructions to control the host data processing apparatus to perform data processing in response to the program instructions; and
register emulating program logic to maintain a data structure to emulate a plurality of registers for storing operands for processing; in which:
in response to a mixed-element-size instruction specifying a first operand and a second operand provided by registers emulated by the register emulating program logic, the instruction decoding program logic is configured to control the host data processing apparatus to perform an arithmetic/logical operation on a plurality of first data elements of the first operand and a plurality of second data elements of the second operand;
where the first data elements have a larger data element size than the second data elements.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing apparatus;

FIG. 2 schematically illustrates an example of processing a mixed-element-size instruction which acts on first and second operands, where the first operand comprises first data elements having a larger data element size than second data elements of the second operand;

FIG. 3 shows an example of a convolution operation commonly used in machine learning applications such as neural networks;

FIG. 4 illustrates a matrix multiplication operation implemented using instructions acting on first and second operands with identical data element sizes;

FIG. 5 shows how processing throughput can be doubled by using a mixed-element-size instruction;

FIG. 6 is a graph showing an analysis of the likelihood of overflow when using an accumulator of reduced size as shown in FIG. 5 compared to FIG. 4;

FIG. 7 schematically illustrates an example of a matrix processing engine for accelerating common matrix operations used for convolutional neural networks, when implemented using instructions acting on first and second operands with identical element sizes;

FIG. 8 schematically illustrates how the processing engine could be modified to support a mixed-element-size instruction;

FIG. 9 illustrates another example of a mixed-element-sized instruction, and also illustrates an operation performed for each result element by the processing engine of FIG. 8;

FIGS. 10 and 11 illustrate how a systolic array microarchitecture designed for same-element-size instructions could be modified to support a mixed-element-sized instruction;

FIG. 12 illustrates a further example of a mixed-element-size instruction;

FIG. 13 is a flow diagram illustrating a method of processing a mixed-element-size instruction; and

FIG. 14 illustrates a simulator example that may be used.

### DESCRIPTION OF EXAMPLES

For typical SIMD instructions operating on first and second operands, it is normal for the data element size of the elements in the first operand to be the same as the data element size for the data elements of the second operand. Although some architectures may support variable data element size, if the data element size for a first operand is changed, the data element size for the second operand also changes to match the data element size of the first operand. This is because in many SIMD or vector instructions defined in instruction set architectures, the instruction may trigger processing of a number of independent lanes of vector processing where each lane processed a single element from the first operand and a corresponding single element from the second operand. As SIMD operations often stay mostly within their respective lanes then it may be expected that the arrangement of first data elements within one or more first operand registers and the arrangement of the second data elements within one or more second operand registers would be symmetric and therefore it follows that one would normally define the first and second data elements as having the same size. Also, even if there are cross-lane operations, defining the two operands with equivalent element size is often seen as giving the greatest flexibility in the way the instruction can be used by software (since even if software wishes to perform the operation on values of different size, the smaller sized value could still fit into a data element of larger size that is stored within the operand registers, with the smaller value from memory being zero- or sign-extended to match the element size of the other operand).

In contrast, in the techniques discussed below a mixed-element-size instruction is provided which specifies first and second operands stored in the registers. In response to the mixed-element-size instruction, an instruction decoder controls processing circuitry to perform an arithmetic or logical operation on first data elements of the first operand and second data elements of the second operand, where the first data elements have a larger data element size than the second data elements. This is counter-intuitive because it goes against the conventional approach of defining the layout of first/second operands for a multi-element operation using a symmetric format using equal data element sizes in the two operands.

It may seem that defining, as an architectural instruction of an instruction set architecture, an instruction which limits the data elements of the second operand to have a smaller element size than the data elements of the first operand would be unnecessary and waste encoding space in the architecture, because one would expect that even if for a particular application the data values to be input as the second data elements have values varying over a narrower range than the values to be input for the first data elements, the processing of such data values could still be carried out using a same-element-size instruction which operates on first and second operands with equal data element sizes. The narrower input data values to be used for the second data elements could simply be packed into elements within the second operand of the same size as the elements of the first operand, and processed using a same-element-size form of the instruction. As existing instructions with a same element size in both first/second operands already would support application to operations involving narrower data values for the second operand, then there may not appear to be any need to use up instruction encoding space in supporting a dedicated instruction limiting the data element size for the second operand to be smaller than the data element size for the first operand.

However, the inventors recognised that by supporting a mixed-element-size instruction as described above where the second data elements of the second operand are smaller in size than the first data elements of the first operand, this allows a single instruction to process a greater number of second data elements than would be possible for the same-element-size instruction. There are some use cases, particularly in the machine learning field, which may require such arithmetic/logical operations to be performed repeatedly on different segments of data elements extracted from data structures stored in memory, and those structures in memory may be relatively large, so any increase in the throughput of elements per instruction can be valuable in reducing the overall processing time for processing the data structures as a whole. Therefore, the mixed-element-size instruction can help to improve processing performance for many common processing workloads, especially in data-intensive fields such as deep learning. Therefore, the inclusion of a mixed-element-size instruction in an instruction set architecture can justify the encoding space used for that instruction, even if the instruction set architecture also includes a same-element-size instruction that could be used to implement the same operations.

The second data elements of the second operand may be packed into a contiguous portion of one or more second operand registers. Hence, there may be no gaps between the positions of the second data elements within the one or more second operand registers. This is possible because the processing circuitry, when processing the mixed-element-size instruction, treats the second operand registers are comprising second data elements with a smaller element size, so that each smaller chunk of data within a contiguous block of register storage can be treated as an independent input data value in the arithmetic/logical operation.

In contrast, for a same-element-size instruction, even if the data values stored in memory are narrower for the second operand than for the first operand, those data values would have to be expanded into second data elements of the same size as the first data elements, by zero-extension or sign-extension, so that the data values can be processed as independent data values by a same-element-size instruction restricted to using the same element size for both operands. In this case, the meaningful data values loaded from memory would not be stored in contiguous portions of the one or more second operand registers (instead the meaningful portions of data would have gaps between them corresponding to the added zero or sign bits).

Hence, by allowing the second data elements to be stored contiguously in registers, the mixed-element-size instruction also enables the full memory bandwidth corresponding to the total width of the one or more second operand registers can be used, rather than needing to artificially limit the width of the data loaded from memory to reduce the amount of data loaded per load instruction to take account of the fact that some parts of the register would need to be filled with zeroes or sign bits. This means that, for processing a given number of second data elements in total, a smaller number of load instructions can be executed to perform the load operations associated with loading the data from memory, which can improve memory bandwidth utilisation.

In one example, the first data elements may also be packed into a contiguous portion of the one or more first operand registers (as well as the second data elements being packed into a contiguous portion of one or more second operand registers as described above). The first operand registers may have the same register size as the second operand registers. Hence, in some examples, the mixed-element-size instruction could operate on first and second operands which both comprise the same amount of data in total (e.g. the total size of register storage used to store the first operand may be equal to the total size of register storage used to store the second operand), but the second operand may be subdivided into elements of a smaller data element size than the first operand. Hence, the number of second data elements processed in the arithmetic/logical operation may be greater than the number of first data elements processed in the arithmetic/logical operation. This is unusual for instructions involving multiple independent data elements (such as typical SIMD/vector instructions) where normally the symmetry between processing lanes would mean that one would expect the number of first data elements to equal the number of second data elements.

The arithmetic/logical operation performed using the first data elements and the second data elements could be any arithmetic operation (e.g. add, subtract, multiply, divide, square root, etc., or any combination of two or more such arithmetic operations) or any logical operation (e.g. a shift operation, or a Boolean operation as AND, OR, XOR, NAND, etc., or any combination of two or more such logical operations). Also, the arithmetic/logical operation could comprise a combination of at least one arithmetic operation and at least one logical operation.

However, the mixed-element-size instruction can be particularly useful where the arithmetic/logical operation comprises a number of multiplications, with each multiplication multiplying one of the first data elements with one of the second data elements and the respective multiplications corresponding to different combinations of first and second data elements. In the field of machine learning there are applications where a set of activation values representing a given layer of the machine learning model are to be multiplied by weights which define parameters controlling how one layer of the model is mapped to a subsequent layer. Such machine learning models may require a large number of multiplications to be performed for different combinations of activations and weights. To reduce the amount of memory needed for storing the model data there are some machine learning algorithms which use weights which have a smaller number of digits than the activations. The mixed-element-size instruction can be particularly useful for supporting such models, as the second operand could be used to represent the weights and the first operand could be used to represent the activations.

In particular, the mixed-element-size instruction can be particularly useful in an implementation where, as part of the multiplications performed for the arithmetic/logical operation, at least two of those multiplications multiply different second data elements with the same first data element. It is common in machine learning that the same activation may need to be multiplied by a number of different weights for generating different activations within a subsequent layer of the model. To perform the calculations needed for performing the model update functions as a whole, there may be many different combinations of weights and activations to multiply together, including where a single weight value needs to be multiplied by many different activations and where a single activation needs to be multiplied by many different weights. Hence, some cross-over between different element positions may be involved in the arithmetic/logical operation. For examples where the arithmetic/logical operation involves multiplication of multiple different second data elements with the same first data element, there can be a particular advantage to using second data elements of a reduced size compared to the first data elements, as this allows a greater number of the required multiplications to be performed in a single instruction than would be possible for a same-element-size instruction acting on first and second operands with equivalent data element size.

As well as performing multiplications, the arithmetic/logic operation could also comprise at least one addition based on one or more products generated in the multiplications. This addition could be between the products generated in different multiplications performed in response to the same mixed-element-size instruction, so that a number of multiplications based on different combinations of first and second data elements are performed and the results of those different multiplications are added together to generate a processing result. Also, addition could be an accumulation operation where one or more products generated in the multiplications could be added to an accumulator value which is defined as a further operand of the mixed-element-size instruction and where the accumulator value does not itself depend on any of the multiplications of first and second data elements performed in response to the mixed-element-size instruction. For example this may be useful where the products of respective first and second data elements need to be added to one or more accumulator values set in response to earlier instructions. In some examples the accumulator value may itself comprise a number of independent data elements and different data elements of the accumulator value may be added to respective sets of one or more products of first/second data elements of the first/second operands of the mixed-element-size instruction. In some cases, the sum of two or more products generated in the multiplications for the mixed-element-size instruction may be added to a given element of the accumulator value. The particular way in which the respective products of first/second data elements are added together or added to accumulator values may depend on the particular implementation of the instruction and on the application for which that instruction is designed.

In one example, the arithmetic/logical operation could comprise a matrix multiplication operation to generate a result matrix by multiplying a first matrix formed of first data elements from the first operand by a second matrix formed of second data elements from the second operand. In some cases, the result matrix could be generated as a standalone result of the matrix multiplication (without adding the result of the matrix multiplication to any accumulator value). Alternatively, the result of the matrix multiplication could be added to previous contents of an accumulator matrix to generate an updated accumulator matrix. Either way, matrix operations can be a common operation used in machine learning processing. By implementing a matrix multiplication instruction using mixed element sizes as described above, this can allow the matrix multiplication operation to process a greater number of data elements per instruction to improve processing throughput and memory bandwidth utilisation, and hence improve performance for such machine learning workloads.

Alternatively, other approaches may provide a mixed-element-size instruction which controls the processing circuitry to perform, as the arithmetic or logical operation, an outer product operation which generates a result matrix comprising a number of result elements based on a vector of first data elements from the first operand and a vector of second data elements from the second operand. In this case, a given result element of the result matrix may depend on the product of a selected first data element and a selected second data element, and each result element of the result matrix may correspond to a different combination of first and second data elements. Again, it is possible that the result element of the result matrix may also depend on an accumulator value (e.g. a previous value of the corresponding element of the result matrix, which could be added to the product of the selected first/second data elements for that position within the result matrix).

Although it could also be used for other applications, one common use case for outer product operations can be as a partial step towards performing a full matrix multiplication. This is because the inputs to the outer product operation could represent a single row/column of data elements forming a first vector operand and a single column/row of a second matrix as a second vector operand. The overall matrix multiplication operation can be split into a number of separate outer product operations, each applied to a different combination of row/column of the first/second matrices, so that the result of the overall processing could be equivalent to the result of performing the matrix multiplication in one instruction. Hence, some processor implementations may not incur the full hardware cost of supporting a complete matrix multiplication operation in a single instruction, but may instead implement outer product instructions which allow a software workload to perform a matrix multiplication using a sequence of instructions. As such outer product instructions may also be used for machine learning workloads, implementing the outer product operation as a mixed-element-size instruction can be useful for similar reasons to those described above for the full matrix multiplication example.

In response to the mixed-element-size instruction, the instruction decoder may control the processing circuitry to generate a result value to be stored to the registers, where the result value comprises a number of result data elements and the result data elements have a larger data element size than the first data elements. Defining larger result data elements than first/second data elements can be useful to handle operations which involve multiplications, where multiplying two values together generates a product which has a larger number of bits than either of the values being multiplied. Again, the result data elements may be packed contiguously into one or more result registers used to store the result.

In a processing system using binary circuit logic, the data element size for a data element may refer to the number of bits in the data element. Hence, a data element of size N may have N bits, and a data element of size N/2 may have N/2 bits. However, it is also possible to build processing systems which use ternary circuit logic where each digit can have three different states, and in this case the data element size refers to the number of ternary digits (or trits) per data element.

In one example the first data elements may have a data element size of N. The second data elements may have a data element size of N/Z, where Z is a power of 2. N and Z may be set to different values for different implementations of the mixed-element-size instruction. Some systems may support a number of variants of the mixed-element-size instruction corresponding to different combinations of N and Z.

However, in one particular example, it can be particularly useful for Z to equal 2 because in the field of neural networks and machine learning, there are a number of important workloads which use matrix multiplications between applications and weights where the weights are half the width of the activations.

In one example, N=8. When Z=2, this means each first data element has 8 digits (bits) and each second data element has 4 digits (bits). There is an increasing amount of research into kernel operations involving 8-bit activations and 4-bit weights, so setting N=8 and Z=2 8-bit first data elements and 4-bit second data elements can be a particularly useful form of the instruction. Nevertheless, other data element sizes are also possible.

In one example where the first data elements have a data element size of N, the result data elements generated in response to the mixed-element-size instruction could have a data element size of 2N. For cases where the arithmetic/logical operation performed for the mixed-element-size involves multiplications of first/second elements and an accumulation (which is common in machine learning), it may seem that using 2N-bit result elements does not give enough room for accommodating carries to prevent overflow. For example, performing multiplications of N-digit first data elements and N/2-digit second data elements would generate 3N/2-digit products, so accumulating these into 2N-digit result data elements would only leave N/2 digits for accumulating carries before there is a risk of overflow. This may be a concern for some machine learning workloads where the results of many different instructions are accumulated together so that the risk of overflow increases with the number of executed instructions. In contrast, for a same-element-size instruction processing first and second data elements both of size N, the product of first/second elements would comprise 2N digits and so storing these into 2N-digit accumulator values would leave no room for extra carries whatsoever, so it is common for the result data elements to be defined as 4N-digit elements (leaving 2N digits spare for accommodating carries beyond the 2N digits generated in a single multiplication, so this would have less risk of overflow). Hence, normally many machine learning workloads are implemented using instructions where the result data elements are 4 times the width of the activation data elements, to give sufficient space for carries. If overflows occur more frequently then either this may reduce the accuracy of the machine learning predictions made by a model using instructions or additional instructions may need to be executed to handle the overflows, harming performance. Hence, one would expect that using the mixed-element-size instruction with first element size N, second element size N/2 and result element size 2N would be harmful to performance or prediction accuracy compared to the same-element-size approach.

In contrast, the inventors recognised from empirical analysis that with the mixed-element-size instruction, even if the result data elements are reduced to 2N digits in size (2 times the width of the first data elements used to represent the activations for a machine learning workload), while this reduces the number of spare digits for carries to N/2 digits (a quarter of the number available in a same-element-size implementation using 4N-digit result elements), in practice for many common workloads overflows still do not occur particular often and so the concerns about overflows occurring too often are misplaced. From empirical analysis of common machine learning workloads, it was found that even if the number of spare digits within the result elements for handling carries is reduced, the likelihood of overflows being caused through accumulations across multiple instructions is relatively low anyway, and so even if no additional overflow detection/resolution instructions are added, the rare occasions when overflow occurs can be tolerated simply by saturating activations at their maximum possible value, and the effect on the overall prediction accuracy of the machine learning model is negligible. Hence, counter-intuitively, the throughput benefits of using the mixed-element-size instruction do not detract from the accuracy of the processing.

In some examples, the mixed-element-size instruction could correspond to a single instance of the arithmetic/logical operation, which processes the first data elements and the second data elements of the first and second operands in a single unified operation. If multiple independent instances of the arithmetic/logical operation are required, this may be implemented using separately executed instances of the mixed-element-size instruction.

However, in other examples, in response to the mixed-element-size instruction, the instruction decoder may control the processing circuitry to perform multiple instances of the arithmetic/logical operation (either in parallel or sequentially), where a given instance of the arithmetic/logical operation is performed on a first subset of the first data elements and a second subset of the second data elements, and each instance of the arithmetic/logical operation corresponds to a different combination of subsets of the first/second data elements that are selected as the first subset and the second subset. Hence, the mixed-element-size instruction could perform multiple sub-operations on respective chunks of data within the first/second operands, where for each sub-operation the elements of the second operand used for that sub-operation have a smaller data element size than the elements of the first operand used for that sub-operation.

For example the first operand could comprise X subsets of first data elements and the second operand could comprise Y subsets of second data elements. The arithmetic/logical operation could generate X*Y result data elements each corresponding to a result of performing one of the instances of the arithmetic/logical operation on a different combination of one of the X subsets of first data elements and one of the Y subsets of second data elements. For example, where the arithmetic or logical operation involves a matrix multiplication operation (or a matrix multiplication and accumulation operation), the first operand could be logically divided into a number of first sub-matrices and the second operand logically divided into a number of second sub-matrices, where each of the X subsets of first data elements corresponds to one of the first sub-matrices of the first operand and each of the Y subsets of second data elements of the second operand corresponds to one of the second sub-matrices of the second operand, and each of the result data elements corresponds to the result of a matrix multiplication (or matrix multiplication and accumulate) performed on one selected sub-matrix from the first operand and one selected sub-matrix from the second operand.

The techniques discussed above may be implemented within a data processing apparatus which has hardware circuitry provided for implementing the instruction decoder and processing circuitry discussed above.

However, the same technique can also be implemented within a computer program which executes on a host data processing apparatus to provide an instruction execution environment for execution of target code. Such a computer program may control the host data processing apparatus to simulate the architectural environment which would be provided on a hardware apparatus which actually supports target code according to a certain instruction set architecture, even if the host data processing apparatus itself does not support that architecture. Hence, the computer program may comprise instruction decoding program logic which decodes program instructions of the target code to control the host data processing apparatus to perform data processing in response to the program instructions (e.g. mapping each instruction of the target code to a sequence of one or more instructions in the native instruction set of the host which implements equivalent functionality). Also, the computer program may have register emulating program logic which maintains a data structure emulating the registers for storing operands for processing which target code defined according to the instruction set architecture being simulated would expect to be provided in hardware. The instruction decoding program logic may support a mixed-element-size instruction as described above, to provide similar processing throughput advantages to those explained for a hardware implemented embodiment as described above. Such simulation programs are useful, for example, when legacy code written for one instruction set architecture is being executed on a host processor which supports a different instruction set architecture. Also, the simulation can allow software development for a newer version of the instruction set architecture to start before processing hardware supporting that new architecture version is ready, as the execution of the software on the simulated execution environment can enable testing of the software in parallel with ongoing development of the hardware devices supporting the new architecture. The simulation program may be stored on a storage medium, which may be an non-transitory storage medium.

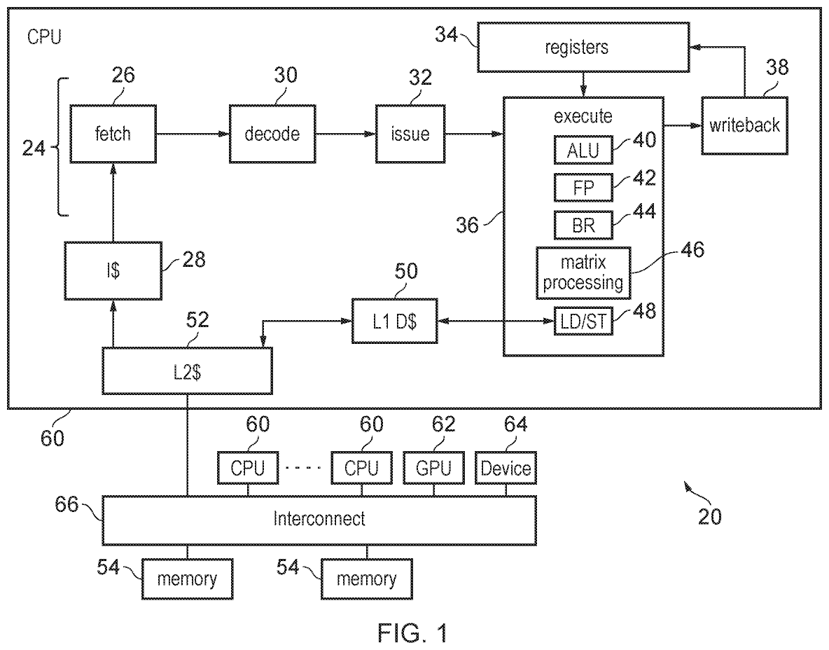

FIG. 1 schematically illustrates an example of a data processing apparatus 20. The data processing apparatus has a processing pipeline 24 which includes a number of pipeline stages. In this example, the pipeline stages include a fetch stage 26 for fetching instructions from an instruction cache 28; a decode stage 30 for decoding the fetched program instructions to generate micro-operations to be processed by remaining stages of the pipeline; an issue stage 32 for checking whether operands required for the micro-operations are available in a register file 34 and issuing micro-operations for execution once the required operands for a given micro-operation are available; an execute stage 36 for executing data processing operations corresponding to the micro-operations, by processing operands read from the register file 34 to generate result values; and a writeback stage 38 for writing the results of the processing back to the register file 34. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 34.

The execute stage 36 includes a number of processing units, for executing different classes of processing operation. For example the execution units may include a scalar arithmetic/logic unit (ALU) 40 for performing arithmetic or logical operations on scalar operands read from the registers 34; a floating point unit 42 for performing operations on floating-point values; a branch unit 44 for evaluating the outcome of branch operations and adjusting the program counter which represents the current point of execution accordingly; a matrix processing unit 46 for matrix processing (which will be discussed in more detail below); and a load/store unit 48 for performing load/store operations to access data in a memory system 28, 50, 52, 54.

In this example, the memory system includes a level one data cache 50, the level one instruction cache 28, a shared level two cache 52 and main system memory 54. It will be appreciated that this is just one example of a possible memory hierarchy and other arrangements of caches can be provided. The specific types of processing unit 40 to 48 shown in the execute stage 36 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

In some implementations the data processing apparatus 20 may be a multi-processor apparatus which comprises a number of CPUs (central processing units, or processor cores) 60 each having a processing pipeline 24 similar to the one shown for one of the CPUs 60 of FIG. 1. Also the apparatus 20 could include at least one graphics processing unit (GPU) 62, and/or other master devices 64 which may communicate with one another and with the CPUs via an interconnect 66 used to access memory 54.

One approach for supporting matrix processing operations can be to decompose the individual multiplications of a given matrix processing operation into separate scalar integer instructions which can be processed on the processing pipeline 24 of a given CPU 60. However, this may be relatively slow.

Another approach to accelerating matrix processing can be to provide, as one of the devices 64 connected to the interconnect 66, a hardware accelerator with dedicated hardware designed for handling matrix operations. To interact with such a hardware accelerator, the CPU 24 would execute load/store instructions using the load/store unit 48, to write configuration data to the hardware accelerator defining the matrix operands to be read from memory by the hardware accelerator and defining the processing operations to be applied to the operands. The CPU can then read the results of the matrix processing back from the hardware accelerator using a load instruction specifying an address mapped to registers within the hardware accelerator. While this approach can be faster than using integer operations within the pipeline, there may nevertheless be an overhead associated with using the load/store mechanism to transfer information between the general purpose processor 60 and the hardware accelerator 64, and also the hardware accelerator approach can create challenges when different virtual machines running on the same processing system need to share access to the hardware accelerator. Therefore, this approach may not scale well in a virtualised implementation having a number of virtual machines.

Therefore, as shown in FIG. 1, it is possible to provide matrix processing circuitry 46 within the regular processing pipeline 24 of a given CPU 60 which can be controlled to perform matrix processing in response to matrix arithmetic program instructions decoded by the decode stage 30 of the pipeline (similar to controlling regular integer or floating point arithmetic operations using the ALU 40 or the floating point unit 42). This avoids the need to transfer data backwards and forwards between the CPU 60 and the hardware accelerator and makes it much simpler to allow a number of different virtual machines to perform matrix operations.

While FIG. 1 shows a multi-processor apparatus 20 having several CPUs 60, this is not essential and the matrix processing circuitry 46 could also be implemented in a single-core system.

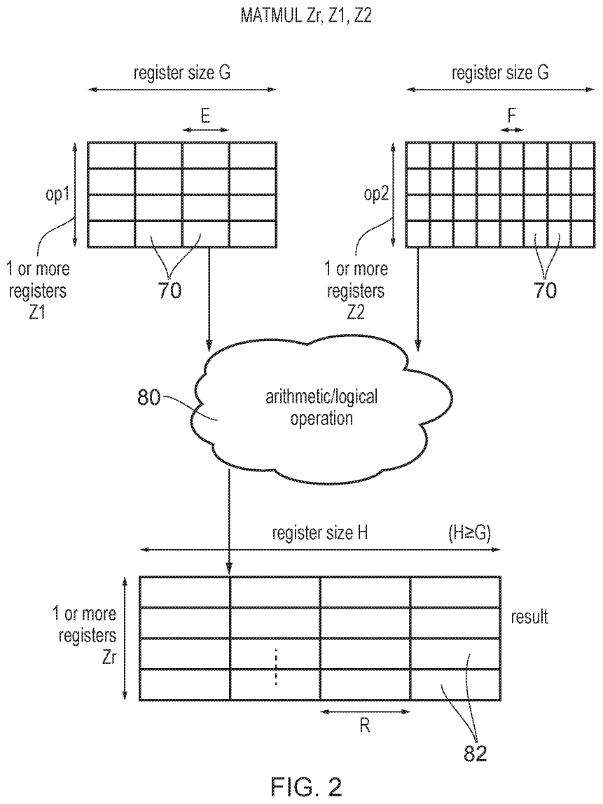

FIG. 2 shows an example of a mixed-element-size instruction, which in this example is a matrix multiplication instruction (MATMUL) supported by the matrix processing circuitry 46. The matrix multiplication instruction specifies one or more destination (result) registers Zr, one or more first source registers Z1 and one more second source registers Z2. In this example each register specified as a source or destination register is a vector register comprising multiple data elements which may represent independent data values. One or more first source registers Z1 provide a first operand op1, which in this example comprises a matrix of data elements 70, where each data element of the first operand op1 has a first data element size E (i.e. each data element of op1 comprises E digits/bits). The second source operand op2 also comprises a matrix of data elements 70, but the data elements of the second operand op2 have a data element size F, where F<E (e.g. F=E/2 or E/4). The second operand op2 is stored in vector registers of the same register size G as the first operand op1, and so as the data element size F for the second operand is smaller than the data element size E for the first operand, the second operand comprises a greater number of data elements 70 than the first operand. The data elements 70 of the second operand are packed continuously into the second source registers Z2, without gaps.

In response to the matrix multiplication instruction, the matrix processing circuitry 46 performs an arithmetic/logical operation 80 on the first and second source operands op0, op1, which in this example is a matrix multiplication operation to multiply the matrix represented by the first operand op1 by the matrix represented by the second operand op2 to generate a result matrix. It will be appreciated that the layout of the physical storage of the data elements in the source register Z1, Z2, may not correspond exactly to the logical arrangement of the elements within the matrix represented by the first or second operand OP1, OP2, for example a single row of a matrix structure could be striped across multiple vector registers, or multiple rows of a matrix structure could be stored within the same vector register.

Based on the matrix multiplication operation 80, a result matrix is generated and stored into one or more destination registers Zr each of register size H (H can equal G or could be greater than G). Each data element 82 of the result matrix may have a certain data element size R, where R>E. For example, R=2E in some examples. For a matrix multiplication, each element 82 of the result matrix corresponds to the value obtained by summing respective products generated by multiplying respective elements of a row of the matrix represented by one of the first and second source operands by corresponding elements within a corresponding column of the other of the first and second source operands (optionally with the sum of products added to the previous contents of the corresponding result element to generate a new value for that result element 82, in an implementation where the MATMUL instruction functions as a matrix-multiply-and-accumulate instruction).

This approach is unusual since normally arithmetic instructions which operate on operands comprising multiple independent data elements would expect both the source operands to have elements of the same data element size (same number of bits). It may be considered surprising that it would be worth expending instruction encoding space within an instruction set architecture on an instruction which restricts the second operand to have a smaller data element size than the first operand, as any operations that could be performed using such a mixed-element-sized instruction could also be performed using a more conventional form of the instruction which has operands of the same element size. However, it is recognised that especially in the field of machine learning, it can be useful to provide a mixed-element-sized instruction as shown in FIG. 2, to improve processing throughput when processing machine learning models.

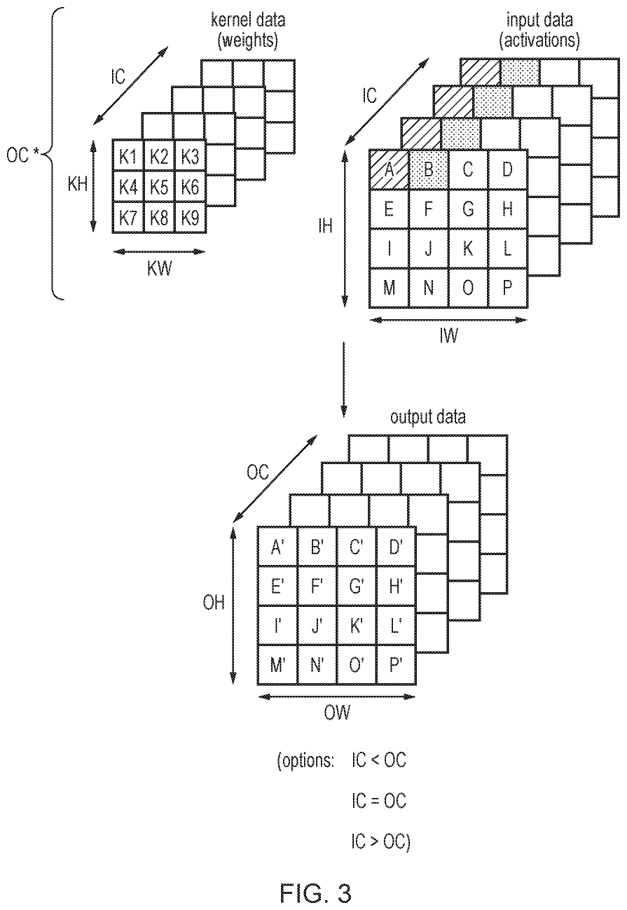

FIG. 3 shows an example of a convolution operation which is commonly used in convolutional neural networks. Convolutional neural networks may comprise a number of layers of processing, where the data generated by one layer serves as the input to a next layer. FIG. 3 shows an example of an operation which may be performed at a given layer of the network. The input data to that layer (also referred to as activations) may be defined as a number of input channels, where each input channel comprises a 2D array of a certain size. In this example there are IC channels of input data and each channel has a height IH and width IW. In this example IH and IW are both equal to 4.

At a given layer of the neural network, the set of input data is transformed into a corresponding set of output data comprising OC output channels where each output channel is of dimensions OH, OW. In this example OH and OW are also equal to 4 (the same as for the input channels), but this is not essential and other examples could change the channel height/width between the input and the output. Similarly, in this example the number of output channels OC is equal to the number of input channels IC, but this is not essential and OC could be either greater than or less than IC.

The function for transforming the input data into the output data is defined by a set of kernel data (or kernel weights). OC sets of IC arrays of kernel weights are defined (so that there are OC*IC arrays in total), and each output channel of output data is formed by processing the corresponding one of the OC sets of kernel arrays and all IC input channels of activations. Each kernel array comprises KH*KW kernel weights—in this example KH and KW are both equal to 3.

To simply the explanation, the convolution operation is explained first assuming that IC=1 and OC=1, so that there is only a single kernel array comprising kernel weights K1 to K9, a single input channel comprising input activations A to P and a single output channel comprises output data A′ to P′ as labelled in FIG. 3. If IC=1, each element of the output data channel may be formed by multiplying the respective kernel weights by the corresponding input activations which are at positions at which the kernel array elements would be positioned if the central kernel weight K5 was positioned over the input data element at the corresponding position to the output data element being generated. For example, when generating the output element F′, the kernel array is logically considered to be positioned over the input channel data so that the central kernel element K5 is positioned over the input activation F which corresponds in position to the output element F′ being generated, and this means the other kernel weights K1, K2, K3, K4, K6, K7, K8, K9 would be positioned over input activations A, B, C, E, G, I, J, K respectively. Hence, respective multiplications of kernel weights and input activations are performed, to add K1*A+K2*B+K3*C+K4*E+K5*F+K6*G+K7*I+K8*J+K9*K=F′. Hence, the positions to be multiplied with each kernel array element depend on the relative position of these other input activations neighbouring the input activation at the position whose output element is being calculated for the output array. Similarly, when calculating the output element G′ then the kernel array would be shifted in position and now the multiplications and sums performed would be to generate G′=K1*B+K2*C+K3*D+K4*F+K5*G+K6*H+K7*J+K8*K+K9*L.

A similar calculation may be performed for each other position within the output channel. When calculating output elements which are near the edges of the output channel, then when the kernel array is positioned with central element K5 over the corresponding input activation position, some of the elements of the kernel array will extend past the edges of the input channel. In a padded convolution, instead of multiplying these kernel weights by a real input value, the kernel weights that extend outside the input channel boundary can be multiplied by a padding value such as 0. Alternatively, an unpadded convolution may not calculate any output elements A′, B′, C′, D′, E′, H′, L′, M′, N′, 0′, P′ etc. which are at positions which would require the kernel array to extend beyond the bounds of the input channel, and may only produce output data for those positions F′, G′, J′, K′ where the kernel can fit entirely within the bounds of the input channel (in this case the dimensions of the output channel may be less than the dimensions of the input channel).

When this operation is scaled up to multiple input channels (IC>1), then there are now IC channels of activations and IC arrays of kernel weights (with a 1:1 mapping between activation channels and kernel weight arrays), and so the single-channel operation described above would be performed for each respective pair of the activation channel and corresponding kernel array, and results obtained for the same position within each set of multiplications added together to form the corresponding element of a single output channel.

For example, the value at position F′ in the output channel shown in FIG. 3 may correspond to the sum of: the value for position F′ resulting from the convolution between kernel array 0 and input data channel 0, plus the value obtained for position F′ by convolving kernel array 1 with input data channel 1, plus the value obtained for position F′ by convolving kernel channel 2 with input channel 2, and so on until all the input channels IC have been processed (the additions do not necessarily need to be performed in this order—it is possible to rearrange the processing to generate equivalent results).

If the number of output channels is scaled up to be greater than 1, then each output channel is generated by applying the convolution operation described above to the IC input channels, but using a different one of the OC sets of IC kernel channels applied to the IC input channels.

FIG. 3 only shows processing of a 4×4 chunk of the input activation data for a given layer of the neural network. In practice, the input data for a given layer may comprise an array of data of much wider dimensions. Also, the neural network as a whole may comprise many layers, so that the output channels from one layer serve as inputs to the next, with different sets of kernel weights learnt by machine learning to provide different transformation functions at different nodes of the network. Hence it can be seen that such neural network as a whole may require an extremely large number of multiplications between different pairs of kernel weights and input activations and additions of these products. The kernel weights and activation values may be multiplied together in many different combinations. For example a given activation A may need to be multiplied by many different kernel weights and a given kernel weight K1 may need to be multiplied with many different activation values. To speed up processing, the kernel weight data and the input activation data can be laid out in memory in structures in a different logical format to the format shown in FIG. 3. For example, the data structures may be structured to allow the multiplications and accumulations needed for a certain layer of the neural network processing to be implemented by performing matrix multiplications. A challenge when implementing matrix processing can be to marshal the transfer of the sets of input data and kernel weights from the memory system 50, 52, 54 to registers 34, to perform the corresponding matrix operations on the loaded data, and manage the transfer of results back from registers 34 to the memory system. The neural network processing may be implemented through an iterative process which may repeatedly load chunks of input data and kernel weight data to the registers 34, perform matrix multiplication on them using the matrix processing circuitry 46, and write results back to matrix structures in memory.

Traditionally, the kernel weights would have the same number of bits as the corresponding activations which they are to be multiplied with. For example, it may be common for each activation value and kernel weight to comprise 32 bits, 16 bits or 8 bits, with identical sizes for the activation and kernel values.

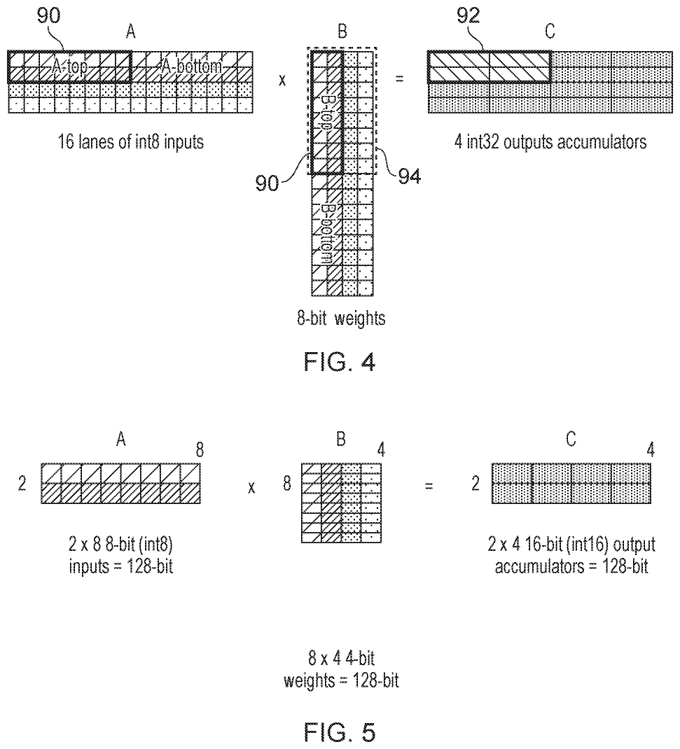

FIG. 4 shows an example of implementing this matrix processing using a same-element-size matrix multiplication instruction which acts on first and second operands with identical data element sizes. In this example, the input activations and weights both comprise 8 bits, so the result of any single multiplication operation on two 8-bit values will be 16-bits wide, and as machine learning processing may require the products of two or more different pairs of activations/weights to be added together (and possibly accumulated with previous elements calculated by earlier instructions), then to avoid loss of accuracy due to overflow, the 16-bit results may be accumulated into 32-bit elements in the result matrix C. Hence, for a same-element-size implementation an input-to-output width ratio of 4:1 may work well. However, an additional source of improved performance can be matrix element reuse. As shown in FIG. 4, the registers could be loaded with a larger number of data elements than can be processed by a single instruction, so that the elements loaded by a single set of load operations can be reused across multiple instructions in different combinations. The portions of the activation and weight matrices indicated using the box 90 in FIG. 4 may represent the portions processed by a single matrix multiplication instruction (e.g. each portion 90 may correspond to a sub-matrix of 2*8 elements of the 4*16-element matrix structure loaded into the registers), and the matrix multiplication instruction could generate a 2*2 output cell 92 within the output matrix C (each element of the 2*2 cell comprising a 32-bit element). The output of one instance of the matrix multiplication instruction only generates a partial value for that output cell 92—in this case corresponding to the multiplication of A-top and B-top shown as portions 90 in FIG. 4. The final value for the output cell 92 may be computed across multiple matrix multiply-and-accumulate instructions by adding the results of corresponding elements derived from matrix multiplications of A-top*B-top, A-top*B-bottom, A-bottom*B-top and A-bottom*B-bottom. The other output cells 92 within the output matrix C can then be performed through similar calculations using different pairs of rows and columns from the loaded activation and weight matrix structures. By reusing the same set of inputs for multiple instructions, this can improve the overall load-to-compute ratio compared to an approach where separate load operations were required to load the operands for each individual instruction.

Use of deeper and wider convolutional neural networks (CNNs) has led to outstanding predictive performance in many machine learning tasks, such as image classification, object detection, and semantic segmentation. However, the large model size and corresponding computational inefficiency of these networks often make it infeasible to run many realtime machine learning applications on resource-constrained mobile and embedded hardware, such as smartphones, AR/VR devices, etc. To enable this computation and size compression of CNN models, one particularly effective approach has been the use of model quantization. Quantization of model parameters to sub-byte values (i.e. numerical precision of 8 bits), especially to 4-bits has shown minimal loss in predictive performance across a range of representative networks and datasets. Some heavily quantized machine learning models may use kernel weights which have fewer bits than the corresponding activations which they are to be multiplied with. For example, there is an increasing interest in using 4-bit weight and 8-bit activations, which means that matrix multiplications between 4-bit weight and 8-bit activations are likely to become a fundamental kernel of many important workloads including neural networks and machine learning, although such multiplications may also be useful for other purposes.

However, In 4-bit-weight networks, the weights are encoded by 4 bits, while the activation matrices are represented by more bits (e.g., 8 bits in this example, although other examples could have larger activations). This creates a read width imbalance between the 4-bit weights, 8-bit activations and output/accumulators compared to previous technology. Ideally, we would like to sustain matched vector width of read and write operands while exploiting 4-bit weights for the best performance. In other words, we would like to utilize the full bandwidth of read and write ports while exploiting 4-bit weights for the best performance.

If such quantized neural network processing was implemented using same-element-size matrix multiplication instructions similar to those shown in FIG. 4, then the 4-bit weights stored in memory could be loaded into a number of 8-bit elements within the “B” operand registers, with each 4-bit weight value from memory sign-extended or zero-extended to fill the remaining 4 bits of each 8-bit element of the “B” operand registers. This would mean that the 4-bit weights would not be packed contiguously into the input registers but would be dispersed into a number of non-contiguous 4-bit chunks with gaps between them corresponding to the locations of the sign extension or zero extension. Having extended the 4-bit weights from memory into 8-bit elements, the matrix multiplication could be performed in the same way as described above for FIG. 4 to generate four 32-bit output accumulator values per instruction (based on the multiplication of 16 (2*8) lanes of 8-bit activations and 16(8*2) lanes of 8-bit weights (expanded from the 4-bit weights in memory). Hence, while this approach would allow the storage overhead of storing the weights in memory to be reduced compared to an approach using 8-bit weights, the processing throughput and memory bandwidth costs would be the same, as the number of elements processed per load instruction or per matrix multiply instruction would still be the same as in FIG. 4.

In contrast, by implementing a mixed-element-size matrix multiplication instruction (or other similar operations) using 4-bit elements instead of 8-bit elements for the operand used for the weight matrix, twice as many values can be accessed from memory per load instruction—this is by design and an intended consequence in order to get a speedup. Subsequently, part of the matrix multiplication hardware can be reused to do twice as many multiplies of narrower width, and the matrix architecture based on the narrower argument can be twice as wide to use all the bits available.

Hence, FIG. 5 shows, for comparison, processing of 8-bit activations and 4-bit weights in an approach supporting a mixed-element size instruction similar to shown in FIG. 2, where the second operand has data elements contiguously packed into registers with a smaller data element size than the data element size of the elements of the first operand. Assuming 4-bit weights and 8-bit activations, the maximum possible result of any single multiplication operation is 12-bits wide. Due to the accumulative nature of a matrix multiplication operation, these 12-bit results can be accumulated into a 16-bit accumulator register. Furthermore, 4-bit weights can improve the virtual bandwidth/vector width of register file by storing larger weight sub-matrices in the same limited-size register file. For example, with 128-bit vector width shown in FIG. 5, the “B” input operand register corresponding to “B-top” 90 that once held a 8×2 sub-matrix of 8-bit elements can now hold a 8×4 sub-matrix of 4-bit elements.

Hence, in the example of FIG. 5 the first operand A comprises the same 2*8 sub-matrix of 8-bit activations as is represented by the portion A-top 90 in FIG. 4, but the second operand B comprises a sub-matrix of 8*4 4-bit weights and so corresponds to the top half 94 of the matrix structure B shown in FIG. 4 (rather than only comprising B-top 90). Hence the number of input elements in the second operand B that can be processed in one instruction is twice as many as in the same-element-size instruction shown in FIG. 4. Similarly, the portion of the result matrix generated in one instruction in the approach shown in FIG. 5 includes twice as many elements as the portion 92 generated in one instruction in the approach shown in FIG. 4. The instruction in FIG. 5 generates a 2*4 matrix of 16-bit result elements, instead of generating a 2*2 matrix of 32-bit elements, but can still use registers of the same size as FIG. 4.

Hence, while the approach shown in FIG. 4 multiplies N-bit activations by N-bit weights to generate 4N-bit output accumulators, in the approach shown in FIG. 5 N-bit activations are multiplied by N/2-bit weights to generate 2N-bit output accumulators. This means that the matrix processing circuitry 46 is able to process twice as many inputs and generate twice as many outputs per instruction as a conventional processor supporting a same element-size instruction. Another advantage is that as it is not necessary to zero-extend or sign-extend the narrower weights stored in memory when loading them into registers, which makes load processing simpler, and also means that the full read/write port bandwidth supported to match the register size used is available for loading the 4-bit weights (rather than needing to artificially limit the read or write bandwidth used for an individual load instruction to half that represented by the register size to allow for the zero-/sign-extension). Hence, support for this instruction can speed up the processing of quantised machine learning networks.

One potential challenge for widespread acceptance of an instruction like this would be overflow violations in the relatively narrow accumulators. While the approach in FIG. 4 uses 32-bit accumulators to accumulate 16-bit products resulting from multiplication of two 8-bit elements, and so has 16 bits spare to accommodate carries before any risk of overflow occurs, in the approach shown in FIG. 5 16-bit accumulators accumulate 12-bit products resulting from multiplication of an 8-bit element and a 4-bit element, so there are only 4 bits spare for accommodating carries before there is a risk of overflow.

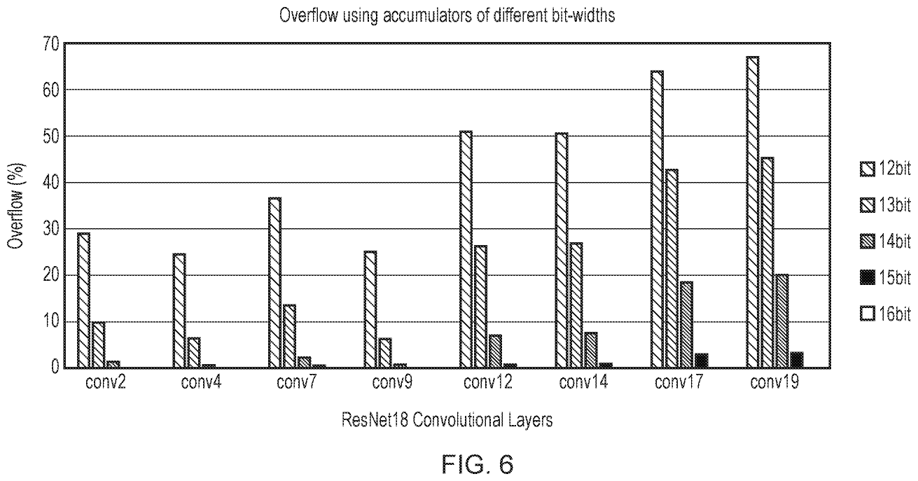

Hence, in the worst case signed 8-bit*4-bit multiplication (+127*−8=−1016) only 32 12-bit results can be accumulated into a 16-bit (−32768 to 32767) register before overflowing. While this would be fine for a single instance of the instruction, typical use cases reuse a stationary accumulator register over multiple instances of the instruction within a loop. In order to observe the amount of overflow that happens in practice while using 16-bit accumulators for performing matrix multiplication between 8-bit activations and 4-bit weights in our proposal, test data from the ImageNet dataset was fed to the ResNet18 architecture where activations and weights are quantized to 8-bit and 4-bit respectively. For 16-bit width of accumulator, almost non-existent (0.05%) overflow (% of accumulation operation causing overflow while generating the output activations of each layer) is observed as shown in FIG. 6 and Table 1. FIG. 6 shows the percentage of accumulation operations causing overflow observed while using accumulators of different bit-widths for performing high throughput matrix multiplication between 8-bit activations and 4-bit weights of the ResNet18 network. Table 1 shows the overflow % (percentage of accumulation operation causing overflow) observed while using a 16-bit accumulator for performing high throughput matrix multiplication between 8-bit activations and 4-bit weights of the ResNet18 network:

TABLE 1

| | Overflow (%) |
|---|---|
| | using 16-bit |
| ResNet18 Layers | accumulator |
| Convolution layer 2 | 0 |
| Convolution layer 4 | 0 |
| Convolution layer 7 | 0 |
| Convolution layer 9 | 0 |
| Convolution layer 12 | 0.001 |
| Convolution layer 14 | 0.0027 |
| Convolution layer 17 | 0.061 |
| Convolution layer 19 | 0.054 |

Table 2 shows the number of matrix-multiply-and-accumulate (MAC) operations (Cin*w*h) performed for generating each output element of different layers of the ResNet18 network, where Cin is the number of input channel values, and w and h are the width and height of each kernel array.

TABLE 2

| | | | | | #MAC operations performed for |
|---|---|---|---|---|---|
| ResNet18 Layers | Cout | Cin | w | h | generating each output element (Cin*w*h) |
| Convolution layer 2 | 64 | 64 | 3 | 3 | 576 |
| Convolution layer 4 | 64 | 64 | 3 | 3 | 576 |
| Convolution layer 7 | 128 | 128 | 3 | 3 | 1152 |
| Convolution layer 9 | 128 | 128 | 3 | 3 | 1152 |
| Convolution layer 12 | 256 | 256 | 3 | 3 | 2304 |
| Convolution layer 14 | 256 | 256 | 3 | 3 | 2304 |
| Convolution layer 17 | 512 | 512 | 3 | 3 | 4608 |
| Convolution layer 19 | 512 | 512 | 3 | 3 | 4608 |

Tables 1 and 2 show that in practice overflow only happens in the largest of neural network layers (which are falling out of favour compared to more efficient modern architectures) where over 2000 multiplication results are accumulated into each 16-bit accumulator result. This demonstrates that in the common case overflow for 16-bit accumulators is very rare.

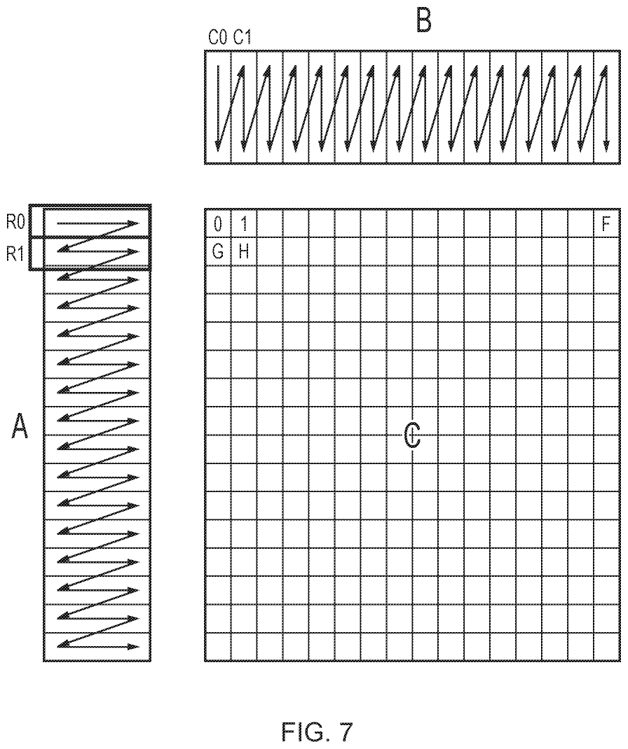

Hence, the approach shown above is not expected to cause significant difficulties concerning the occurrence of overflow. If overflow detection is desired, making the overflow ‘sticky’ (in that the max negative or positive value does not change once it is reached/overflowed) can enable a simple error detection routine as well by scanning the outputs for any −MAX_VALUE and +MAX_VALUE results. Additionally, since machine learning workloads are tolerant to such numerical errors, in most use cases the sticky max values can just be used directly in the next stage of compute without any checking routine. Some implementations may provide matrix processing circuitry 46 which is able to accelerate matrix multiplication by generating, as the result of a single instruction, result values representing a two dimensional tile of elements as shown in FIG. 7. It will be appreciate that FIG. 7 shows the logical arrangement of the result elements—it is not necessary for the physical storage of the result elements to match the logical arrangement. Here, each result element is formed based on a matrix multiplication of a corresponding 1D row of elements of the first source operand and a corresponding 1D column of elements of a second source operand. For example, the result element at the position marked 0 in the result tile C may correspond to the result of performing a matrix multiplication on row R0 and column C0, i.e. the value at position 0 in the result tile C corresponds to the product of the first element of row R0 and the first element of column C0 plus the product of the second element of row R0 and the second element of column C0, plus further products for successive pair of elements, to produce a single element as the result to be placed in the portion of the result tile registers corresponding to position 0. If accumulation is also used, then the sum of the products from the matrix multiplication can also be added to the previous contents of element 0 of the result tile, to generate a new result value for that element position 0. Similarly, the result value at position 1 of the result tile is generated based on a matrix multiplication of row R0 of the first operand A with column C1 of the second operand B, the result value at position G is dependent on a matrix multiplication of row R1 of the first operand with column C0 of the second operand, and the result value at position H depends on a matrix multiplication of row R1 and column C1. Similar operations may be performed for each other pair of rows and columns of the input operands to generate the corresponding result values within the result tile C. This approach can greatly speed up matrix processing because many different combinations of respective rows and columns can be calculated in a single instruction.

FIG. 7 shows operation of the matrix multiplication engine for an approach where each data element in both operands A and B is of the same size, e.g. 8-bits. Hence, the accumulator array tile C of the register file used by the matrix processing circuitry 46 would comprise a square array (e.g. 16*16 in this example) of elements, where each element comprises 32 bits (4 times the input value to mirror the approach shown in FIG. 4). Some implementations may support variable element size, so that a given row/column of the input operands may be repartitioned to represent either a single 32-bit value, two 16-bit elements or four 8-bit elements, say, but regardless of which element size is selected, the element size would be the same for both source operands A, B.

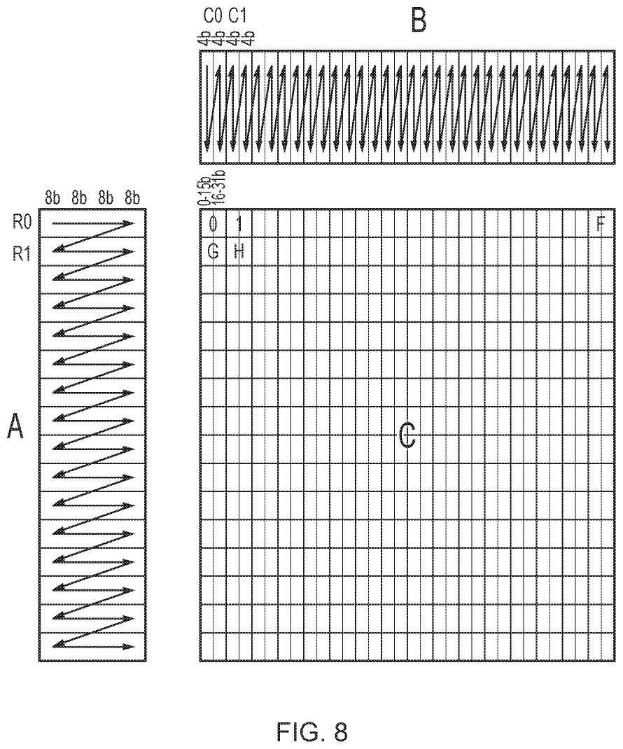

FIG. 8 shows how the same registers for such a matrix multiplication engine can be adapted to support mixed-element size instructions as described earlier. In this example, the A and B input operands are 64 bytes, with the “A” operand (which can be used for activations) comprising 16 rows with each row comprising 4 8-bit values, and the “B” operand (which can be used for weights) comprising 16 columns with each column comprising 8 4-bit values (or alternatively B can be viewed as 32 columns each comprising 4 4-bit values). That is, each of the 32-bit columns of the B operand shown in FIG. 7 are effectively divided into two, and output to different halves of the corresponding 32-bit elements in the corresponding column of the accumulator register tile C. The MAC outputs between 8- and 4-bit operands are accumulated into 16-bit accumulator registers of the accumulator register tile C having the same 16 32-bit rows and 16 32-bit wide columns (as in FIG. 7), but now each 32-bit element of the register tile C can hold two 16-bit elements. As the output of a MAC operation between 8- and 4-bit operands can fit into a 16-bit wide accumulator as shown in FIG. 5, each register of the accumulator register file can now be repurposed for accumulating two 16-bit wide MAC output values.

Hence, the register sizes for the first input operand A and second input operand B and accumulator tile C can still be the same as in FIG. 7, but with a different sub-partitioning to account for the narrower element size in operand B. This means that even in circuit implementations which accelerate matrix multiplication using registers designed to support same-element-size instructions as shown in FIG. 7, it is possible to adapt those circuit implementations to implement the mixed-element-size instruction without any change to the register storage being needed. Instead, the change can be in the way in which the processing circuit logic of the matrix processing circuitry 46 uses the bits extracted from those registers.

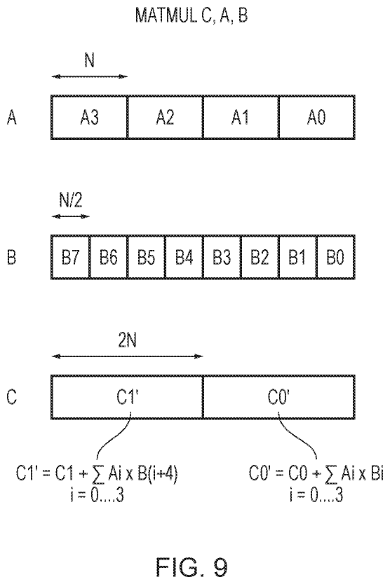

FIG. 9 schematically illustrates the operation performed by the matrix processing circuitry 46 to generate one single 32-bit element in the result tile C shown in FIG. 8. Each other 32-bit element can be generated by a similar operation, but applied to different rows/columns of operands A/B as the input operands. Hence, in the example of FIG. 9 operand A corresponds to a single row R within the first operand A of FIG. 8 and operand B corresponds to a single 32-bit column C FIG. 8, but where the column is logically split into smaller N/2 bit elements than the N-bit element shown within operand A.

Hence, in this example the updated value C0′ for the lower half of the result value is generated with a value:

$$C {0}^{′} = C 0 + {\sum }_{i = 0 … 3} {A}_{i} \times {B}_{i}$$

(that is the value obtained by accumulating the element-by-element products of all the elements of the first operand with the elements in the lower half of the second operand B, and adding the result to the previous value in the lower half of the corresponding accumulator register at the relevant position in the result tile).

Similarly, the top half C1′ of the accumulator result is obtained by adding the previous value in the top half C1 of the corresponding result tile position to the sum of the products of each of the elements of the first operand A with corresponding elements within the top half of the second operand B according to the equation

$$C {0}^{′} = C 0 + {\sum }_{i = 0 … 3} {A}_{i} \times {B}_{i + 4}$$

(clearly, other examples may have a different number of elements per operand, so the sum may involve a different number of products than 4).

Hence, the mixed element size operations can still work even in a matrix multiplication engine where the results tile C is represented as a two dimensional set of elements where the height and width of the result tile are equal, since each individual element which would otherwise be used for storing a single accumulator result can be repurposed to store two separate half width results resulting from combination of the row of operand A with the respective halves of the operand B having the smaller element sizes. This enables double the throughput as a greater number of kernel weights can be processed per iteration.

The operation shown in FIG. 9 is described above as implementing one sub-calculation used to generate one 32-bit element of the result tile in a matrix multiplication engine as shown in FIG. 8. However, it would also be possible for the operation shown in FIG. 9 to be implemented as a standalone instruction which only generates a single result C from two operands A, B, rather than repeating the operation for many different combinations of input rows/columns to generate a 2D array of results as in FIG. 8. Even in a standalone instruction producing the outputs for a single result register C as shown in FIG. 9, the use of a mixed-element-size instruction can be useful to improve throughput of elements processed per instruction. Hence, FIG. 9 in itself shows an example of a mixed-element-size instruction even if not implemented using the circuitry shown in FIG. 8.

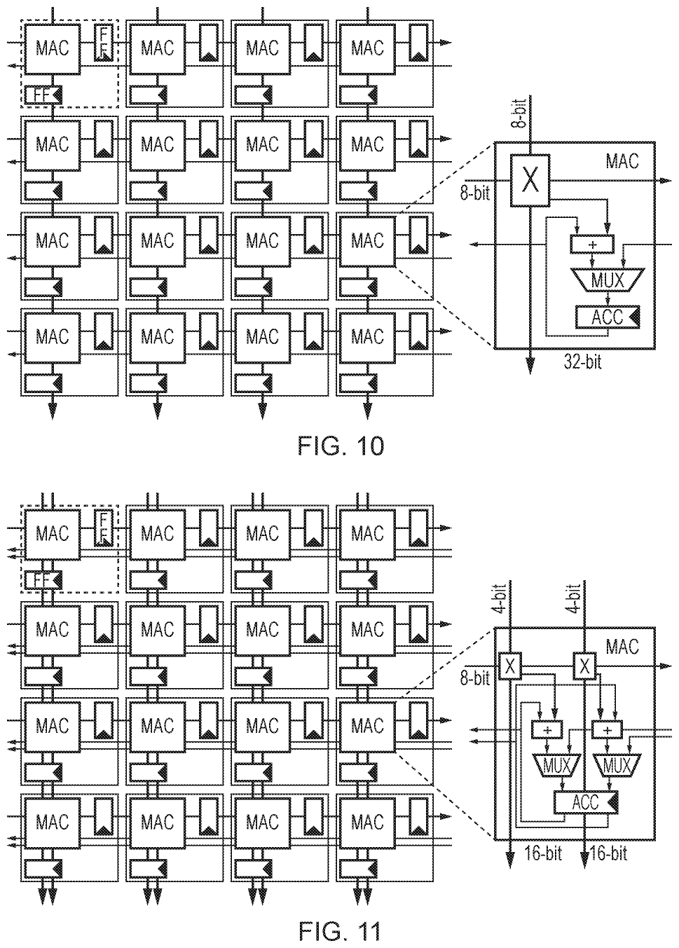

FIGS. 10 and 11 show another example of how processing circuitry designed for performing the multiply-and-accumulate operations that are typical in deep-learning neural networks (DNNs) can be adapted to support the mixed-element-size instruction. A convolutional operation in DNN layers are typically implemented by lowering 2D convolution to general matrix multiply (GEMM) kernels, which are typically the runtime bottleneck when executed on CPUs, motivating hardware acceleration. Spatial architectures are a class of accelerators that can exploit high compute parallelism of GEMM kernels using direct communication between an array of relatively simple processing engines (PEs). The systolic array (SA) is a coarse-grained spatial architecture for efficiently accelerating GEMM. The SA consists of an array of MAC processing elements (PEs), which communicate operands and results using local register-to-register communication only, which makes the array very efficient and easily scalable without timing degradation.

The proposed matrix multiplication instruction at different vector widths (e.g., 128-bit vector width, etc. as shown in the examples above) will not only play a vital role in offering 2× improvement in throughput of matrix multiplication involving 4-bit weights and 8-bit activations in future CPUs, but also will be effective to support MAC operation between 8- and 4-bit operands in state-of-the-art DNN hardware accelerators (e.g., TPU, etc.) and offer similar improvement in matrix multiply performance seamlessly without violating the various implementation constraints.

FIG. 10 shows the structure of a SA designed for supporting multiplications involving operands with equal element size. Each MAC operation in the SA requires two 8-bit operand registers. The 16-bit products are collected into the 32-bit accumulator buffers. This SA organization enables output-stationary dataflow, which keeps the larger 32-bit accumulators in place and instead shifts the smaller 8-bit operands.

FIG. 11 shows how a MAC operation acting on 8-bit and 4-bit operands can be performed using a SA architecture. The 8-bit operand registers now can accommodate two 4-bit weight values and a MAC unit now can perform two multiply-and-adds between 8-bit and 4-bit operands values to generate two 12-bit products. The 12-bit products in turn are accumulated into 16-bit accumulators, thus enabling the 32-bit accumulator buffer of the SA of FIG. 10 to be re-purposed for collecting two 16-bit wide MAC output values. Thus the MAC operation between 8-bit and 4-bit operands generating 16-bit output values can be seamlessly integrated into the SA matrix multiplication engine to achieve 2× improvement in MAC throughput without violating the implementation constraints around the size of operand buffers and accumulator buffers. Similarly, a SA architecture that enforces weight-stationary dataflow can easily be extended to support the proposed matrix multiplication operation involving asymmetric bit-width operands. Weight-stationary dataflow keeps the smaller 8-bit weights in place and shifts the larger 32-bit accumulator values.

Hence, the circuitry shown in FIG. 11 could be used within the matrix processing circuitry 46 of the processing circuitry, to implement matrix multiplication operations for a mixed-element-size instruction.

The above examples all use an example of a matrix multiplication as the arithmetic/logical operation 80 to be performed in response to the mixed-element-size instruction. However, it is also possible to perform other operations on operands with differing element sizes.

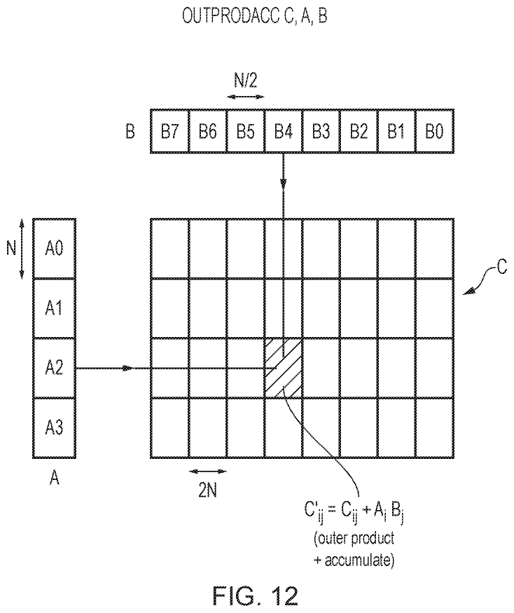

For example, FIG. 12 shows an example where the operation performed as the arithmetic/logical operation 80 is an outer product and accumulate operation, not a full matrix multiplication. In this example, the first operand A is an input vector comprising a certain number of N-bit data elements and the second operand B is a second input vector comprising N/2-bit data elements. A and B are stored in registers of equivalent size and so operand B has twice as many data elements as operand A. The result of the outer product and accumulate instruction is a result matrix C which comprises a 2D array of 2N-bit elements, where each element corresponds to the result of adding the previous value of that accumulator element with the product of a single element from operand A and a single element from operand B, where for each element position within the accumulator matrix C the positions of the combination of elements selected from the first and second operands B is different. That is, for a given element C′ᵢⱼ of the accumulator matrix C, the value generated by the outer product of an accumulate instruction is C′ᵢⱼ=Cᵢⱼ+Aᵢ×Bⱼ. This operation can be performed (in parallel or sequentially) for each respective pair of different values for i and j, to generate the full 2D array of result values C. It would also be possible to implement a non-accumulating outer product instruction where C′ᵢⱼ=Aᵢ×Bⱼ and does not depend on the previous contents of the corresponding result element Cᵢⱼ.

Such an outer product (optionally with accumulate) operation shown in FIG. 12 does not implement a full matrix multiplication operation because it only generates the products of certain pairs of elements but does not add the products obtained from different pairs of elements of the input operands A and B together. However, by repeating the outer product (and accumulate) operation and applying it to different input rows or columns of input matrices in an iterative process, the same result can be generated as would be generated in a full matrix multiplication operation, so outer product operations can also be useful for machine learning processing such as in the convolutional neural networks described with reference to FIG. 3. Hence, as for the matrix multiplications, it can be useful to support a mixed-element-size outer product instruction to provide improved performance for machine learning applications using quantized neural networks where the kernel weights are narrower than the activations.

The examples discussed above are just some examples of possible mixed-element-size instructions which could use input operands having asymmetric data element sizes. It will be appreciated that other examples of the instruction could apply a different arithmetic/logical operation to the first/second operands. However, the technique can be particularly useful for operations which involve various multiplications of different combinations of elements from the first operand with elements from the second operand, as such operations may need to generate many different multiplications for different elements and so using the smaller element width in the second operand can greatly improve the throughput of processing as fewer instructions are needed to process a certain number of input elements within a data structure in memory.

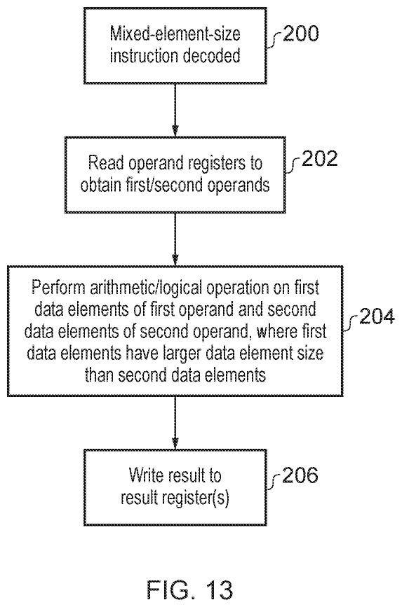

FIG. 13 illustrates a flow diagram showing processing of a mixed-element-size instruction. At step 200 the mixed-element-size instruction is decoded by the instruction decoder 30 within the processing pipeline. In response, the decoder generates control signals to control remaining stages of the pipeline to perform the operations represented by the instruction. At step 202 the signals generated by the instruction decoder control register read ports to read the registers from the register file 34 that are designated as storing the first and second operands for the instruction. At step 204 the execute stage 36 performs an arithmetic and/or logical operation on first data elements of the first operand and second data elements of the second operand, where the first data elements have a larger data element size than the second data elements. Although the examples described above describe the matrix processing circuitry 46 as performing the arithmetic or logical operation, in other examples it could be one of the other execute units that performs this operation, such as the integer ALU 40 or the floating point unit 42. At step 206 the result generated by performing the arithmetic or logical operation is written to one or more result registers within the register file 34.

In the examples given above, the size of the data elements in the first operand is 8-bits and the size of the data elements in the second operand is 4-bits, which is useful for handling the quantized neural network processing with 4-bit weights and 8-bit activations as described above. However, it will be appreciated that other examples could have different data element sizes for the first and second operand, and the ratio between the first data element size and the second data element size does not need to be 2:1. Other examples could use a 4:1 or 8:1 ratio between the first data element size and the second data element size for example.

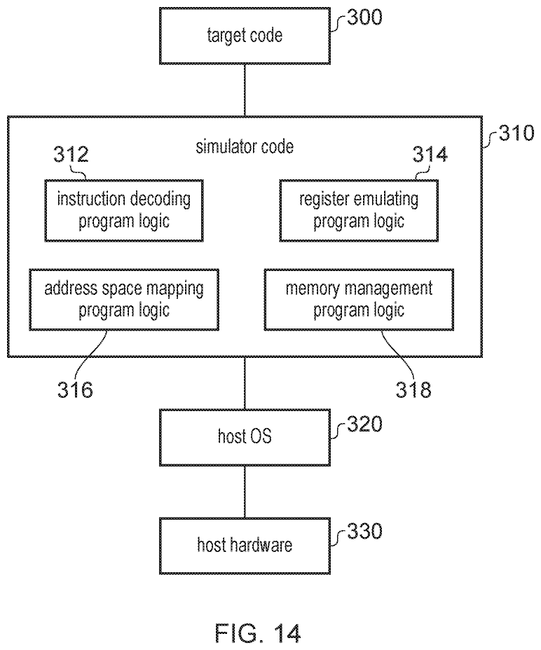

FIG. 14 illustrates a simulator implementation that may be used. While the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 330, optionally running a host operating system 320, supporting the simulator program 310. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 330), some simulated embodiments may make use of the host hardware, where suitable.

The simulator program 310 may be stored on a computer-readable storage medium (which may be a non-transitory medium), and provides a program interface (instruction execution environment) to the target code 300 (which may include applications, operating systems and a hypervisor) which is the same as the interface of the hardware architecture being modelled by the simulator program 310. Thus, the program instructions of the target code 300, including mixed-element-size instructions described above, may be executed from within the instruction execution environment using the simulator program 310, so that a host computer 330 which does not actually have the hardware features of the apparatus 2 discussed above can emulate these features.

Hence, one example provides a computer program 310 which, when executed on a host data processing apparatus, controls the host data processing apparatus to provide an instruction execution environment for execution of instructions of target code; the computer program comprising: instruction decoding program logic 312 to decode program instructions to control the host data processing apparatus to perform data processing in response to the program instructions; and register emulating program logic 314 to maintain a data structure to emulate a plurality of registers for storing operands for processing; in which: in response to a mixed-element-size instruction specifying a first operand and a second operand provided by registers emulated by the register emulating program logic 314, the instruction decoding program logic 312 is configured to control the host data processing apparatus to perform an arithmetic/logical operation on a plurality of first data elements of the first operand and a plurality of second data elements of the second operand; where the first data elements have a larger data element size than the second data elements. The computer program may be stored on a computer-readable recording medium. The recording medium may be a non-transitory recording medium.

For example, the instruction decoding program 312 may comprise instructions which check the instruction encoding of program instructions of the target code, and map each type of instruction onto a corresponding set of one or more program instructions in the native instruction set supported by the host hardware 330 which implement corresponding functionality to that represented by the decoded instruction. The register emulating program logic 314 may comprise sets of instructions which maintain a data structure in the virtual address space of the host data processing apparatus 330 which represents the register contents of the registers 34 which the target code expects to be provided in hardware, but which may not actually be provided in the hardware of the host apparatus 330. Instructions in the target code 300, which in the simulated instruction set architecture which are expected to reference certain registers, may cause the register emulating program logic 314 to generate load/store instructions in the native instruction set of the host apparatus, to request reading/writing of the corresponding simulated register state from the emulating data structure stored in the memory of the host apparatus. Similarly, the simulation program 310 may include memory management program logic 318 to implement virtual-to-physical address translation (based on page table data) between the virtual address space used by the target code 300 and a simulated physical address space which, from the point of view of the target code 300 is expected to refer to actual physical memory storage, but which in reality is mapped by address space mapping program logic 316 to regions of virtual addresses within the virtual address space used by the real host data processing apparatus 330 (which may itself then be subject to further address translation into the real physical address space used to reference the host memory).

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
an instruction decoder to decode program instructions;
processing circuitry to perform data processing in response to the program instructions decoded by the instruction decoder; and
a plurality of registers to store operands for processing by the processing circuitry; in which:
in response to a mixed-element-size instruction specifying a first operand and a second operand stored in the registers, the instruction decoder is configured to control the processing circuitry to perform an arithmetic/logical operation on a plurality of first data elements of the first operand and a plurality of second data elements of the second operand,
wherein the first data elements have a larger data element size than the second data elements, and
wherein a number of independent data values represented by the second data elements processed in the arithmetic/logical operation is greater than a number of independent data values represented by the first data elements processed in the arithmetic/logical operation.

2. The apparatus according to claim 1, in which the plurality of second data elements are packed in a contiguous portion of one or more second operand registers.

3. The apparatus according to claim 2, in which the plurality of first data elements are packed into a contiguous portion of one or more first operand registers; and
the one or more first operand registers and the one or more second operand registers have the same register size.

4. (canceled)

5. The apparatus according to claim 1, in which the arithmetic/logical operation comprises a plurality of multiplications, each multiplication multiplying one of the first data elements with one of the second data elements, the plurality of multiplications corresponding to different combinations of first and second data elements.

6. The apparatus according to claim 5, in which at least two of the plurality of multiplications multiply different second data elements with the same first data element.

7. The apparatus according to claim 5, in which the arithmetic/logical operation comprises at least one addition based on one or more products generated in the plurality of multiplications.

8. The apparatus according to claim 5, in which the arithmetic/logical operation comprises performing one or more accumulation operations, each accumulation operation comprising adding one or more products generated in the plurality of multiplications to an accumulator value.

9. The apparatus according to claim 1, in which the arithmetic/logical operation comprises a matrix multiplication operation to multiply a first matrix formed of first data elements from the first operand by a second matrix formed of second data elements from the second operand to generate a result matrix.

10. The apparatus according to claim 1, in which the arithmetic/logical operation comprises an outer product operation to generate a result matrix comprising a plurality of result elements based on a vector of first data elements from the first operand and a vector of second data elements from the second operand, a given result element of the result matrix depending on the product of a selected first data element and a selected second data element, and each result element of the result matrix corresponding to a different combination of first and second data elements.

11. The apparatus according to claim 1, in which in response to the mixed-element-size instruction, the instruction decoder is configured to control the processing circuitry to generate a result value to be stored to the registers, the result value comprising a plurality of result data elements, in which the result data elements have a larger data element size than the first data elements.

12. The apparatus according to claim 1, in which the first data elements have data element size N, and the second data elements have data element size N/Z, where Z is a power of 2.

13. The apparatus according to claim 11, in which the first data elements have data element size N and the result data elements have data element size 2N.

14. The apparatus according to claim 12, in which N=8.

15. The apparatus according to claim 12, in which Z=2.

16. The apparatus according to claim 1, in which in response to the mixed-element-size instruction, the instruction decoder is configured to control the processing circuitry to perform a plurality of instances of the arithmetic/logical operation, where a given instance of the arithmetic/logical operation is performed on a first subset of the first data elements and a second subset of the second data elements, each instance of the arithmetic/logical operation corresponding to a different combination of subsets of the first data elements and the second subset selected as the first subset and the second subset.

17. The apparatus according to claim 16, in which the first operand comprises X subsets of first data elements, the second operand comprises Y subsets of second data elements, and the arithmetic/logical operation generates X*Y result data elements each corresponding to a result of performing one of the instances of the arithmetic/logical operation on a different combination of one of the X subsets of first data elements and one of the Y subsets of second data elements.

18. A data processing method comprising:
decoding program instructions using an instruction decoder;
performing data processing using processing circuitry in response to the program instructions decoded by the instruction decoder; and
storing, in registers, operands for processing by the processing circuitry;
the method comprising:
in response to a mixed-element-size instruction specifying a first operand and a second operand stored in the registers, controlling the processing circuitry to perform an arithmetic/logical operation on a plurality of first data elements of the first operand and a plurality of second data elements of the second operand,
wherein the first data elements have a larger data element size than the second data elements, and
wherein a number of independent data values represented by the second data elements processed in the arithmetic/logical operation is greater than a number of independent data values represented by the first data elements processed in the arithmetic/logical operation.

19. A non-transitory storage medium storing a computer program for controlling a host data processing apparatus to provide an instruction execution environment for execution of instructions of target code; the computer program comprising:
instruction decoding program logic to decode program instructions to control the host data processing apparatus to perform data processing in response to the program instructions; and
register emulating program logic to maintain a data structure to emulate a plurality of registers for storing operands for processing; in which:
in response to a mixed-element-size instruction specifying a first operand and a second operand provided by registers emulated by the register emulating program logic, the instruction decoding program logic is configured to control the host data processing apparatus to perform an arithmetic/logical operation on a plurality of first data elements of the first operand and a plurality of second data elements of the second operand;
wherein the first data elements have a larger data element size than the second data elements, and
wherein a number of independent data values represented by the second data elements processed in the arithmetic/logical operation is greater than a number of independent data values represented by the first data elements processed in the arithmetic/logical operation.
